(19) United States
(12) Patent Application Publication
(10) Pub. No.: US 2022/0108644 A1
(43) Pub. Date: Apr. 7, 2022

(54) DISPLAY PANEL

(71) Applicant: TCL China Star Optoelectronics Technology Co., Ltd., Shenzhen, Guangdong (CN)

(72) Inventor: Xiaoli Fu, Shenzhen (CN)

(73) Assignee: TCL China Star Optoelectronics Technology Co., Ltd., Shenzhen, Guangdong (CN)

(21) Appl. No.: 16/762,347

(22) PCT Filed: Apr. 8, 2020
(86) PCT No.: PCT/CN2020/083652

§ 371 Date: May 7, 2020

(30) Foreign Application Priority Data
Mar. 25, 2020 (CN) 202010216895.8

(51) Int. Cl. G09G 3/20

(52) U.S. Cl. CPC G09G 3/20; G09G 2310/0289; G09G 2310/0286; G09G 2310/0267; G09G 2310/0283; G09G 2310/08; G09G 2310/0291

(57) ABSTRACT

A display panel, including a gate array substrate; a first flexible circuit board connected to the gate array substrate; a printed-circuit board connected to the first flexible circuit board, and provided with a central control board, wherein the central control board outputs a gate array driving signal; a second flexible circuit board disposed on a side edge of the gate array substrate; and a level shifter provided on the second flexible circuit board and connected to the central control board, wherein the level shifter is configured to raise the gate array driving signal, thereby achieving reduction in panel manufacturing costs, improving panel design flexibility, and controlling a scanning direction of the gate drive circuit.

### FIELD OF INVENTION

The present disclosure relates to the field of display technologies, and more particularly, to a display panel.

### BACKGROUND OF INVENTION

Please refer to FIG. 1, which is a block diagram of a display panel including a gate driving circuit of the prior art. As shown in FIG. 1, in the display panel 100, a chip on film (COF) 120 is provided between a printed-circuit board 110 and a gate array substrate GOA1, a level shifter 111 is disposed in the printed-circuit board 110, and the gate array substrate GOA1 is electrically connected to the level shifter 111.

However, the prior art has following defects:

First, a price of the level shifter is high, and coupled with complexity of peripheral devices matched with the level shifter, results in an increased manufacturing cost of panels of the prior art. Furthermore, as number of clock signals of the gate array substrate changes, it is often impossible to find the level shifter used directly; in other words, a design of multiple channel level shifters and corresponding peripheral circuit is often required to complete the display panel, which affects design flexibility. In addition, the panels of the prior art cannot change a scanning direction of the gate driving circuit.

Therefore, there is a need to provide a better display panel to solve the problems in the prior art.

### SUMMARY OF INVENTION

In order to solve the above problems, the present disclosure proposes a display panel, which can reduce panel manufacturing costs, improve panel design flexibility and control the scanning direction of a gate array driving circuit.

To achieve the above objective, the present disclosure provides a display panel including a gate array substrate; a first flexible circuit board connected to the gate array substrate; a printed-circuit board connected to the first flexible circuit board, and provided with a central control board, the central control board (timing controller, T-CON) outputs a gate array driving signal; a second flexible circuit board disposed on a side edge of the gate array substrate; and a level shifter provided on the second flexible circuit board and connected to the central control board, wherein the level shifter is configured to raise the gate array driving signal

In one embodiment of the present disclosure, the second flexible circuit board further comprises a shift register and an output buffer, the shift register receives the gate array driving signal and generates a temporary gate array driving signal, the level shifter is configured to raise the temporary gate array driving signal and transmit the temporary gate array driving signal to the output buffer, and the output buffer output a temporary gate array control signal to control a plurality of thin film transistors of the gate array substrate turning on or off.

In one embodiment of the present disclosure, the gate array control signal is configured to comprise a plurality of clock control signals.

In one embodiment of the present disclosure, the number of the clock control signals is twelve.

In one embodiment of the present disclosure, the gate array driving signal is configured to comprise a low frequency signal, the second flexible circuit board is configured to further comprise a low frequency signal separation element, and the low frequency signal separation element is configured to convert the low frequency signal into a first low frequency signal and a second low frequency signal

In one embodiment of the present disclosure, the second flexible circuit board further comprises a scanning direction control element which is configured to control a scanning direction of a gate driving circuit, and control the scanning direction of the gate driving circuit by receiving a scanning direction control signal.

In one embodiment of the present disclosure, the scanning direction control element further comprises a receiving unit that receives the scanning direction control signal.

In one embodiment of the present disclosure, the gate array driving signal comprises a start signal, and the second flexible circuit board comprises a start signal separation element, the start signal separation element is configured to convert the start signal into a first start signal and a second start signal.

In one embodiment of the present disclosure, the gate array driving signal comprises a left start signal and a right start signal, and the second flexible circuit board is configured to further comprise a start signal conversion element, the start signal conversion element is configured to convert the left start signal and the right start signal into a first start signal and a second start signal.

Since the display panel provided by the present disclosure includes a gate array substrate; a first flexible circuit board connected to the gate array substrate; a printed-circuit board connected to the first flexible circuit board, and provided with a central control board, wherein the central control board outputs a gate array driving signal; a second flexible circuit board disposed on a side edge of the gate array substrate; and a level shifter provided on the second flexible circuit board and connected to the central control board, wherein the level shifter is configured to raise the gate array driving signal, a reduction in panel manufacturing costs can be achieved, improving panel design flexibility and controlling the scanning direction of the gate drive circuit.

### DESCRIPTION OF DRAWINGS

FIG. 1 illustrates a block diagram of a display panel including a gate driving circuit of the prior art.

FIG. 2 illustrates a block diagram of a display panel according to one embodiment of the present disclosure.

FIG. 3 illustrates a block diagram of a thin film encapsulation integrated circuit according to one embodiment of the present disclosure.

FIG. 4 illustrates a block diagram of a flip-chip integrated circuit according to one embodiment of the present disclosure.

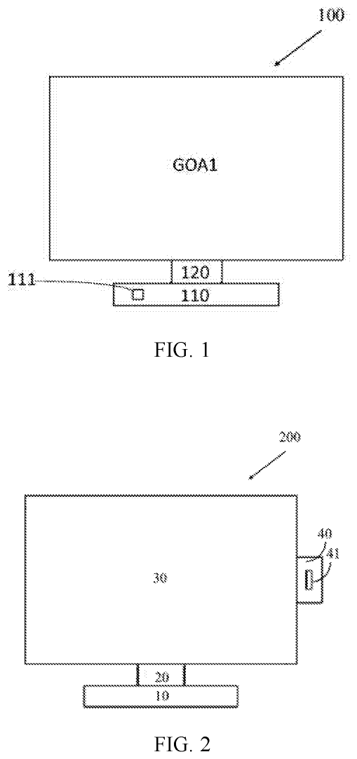

### DETAILED DESCRIPTION OF PREFERRED EMBODIMENTS

The following is a description of each embodiment with reference to additional figures to illustrate specific embodiments in which the present disclosure can be implemented. The directional terms mentioned in the present disclosure, such as up, down, front, back, left, right, inside, outside, side, etc., are only directions referring to the figures. Therefore, the directional terminology is used to illustrate and explain the present disclosure, not to limit it.

In the figures, similarly structured units are denoted by the same reference numerals.

Please refer to FIG. 2, which illustrates a block diagram of a display panel according to one embodiment of the present disclosure. The display panel 200 includes a gate array substrate 30; a first flexible circuit board 20 connected to the gate array substrate 30; a printed-circuit board 10 connected to the first flexible circuit board 20 and provided with a center control board 11 (timing controller, T-CON), wherein the central control board 11 outputs a gate array driving signal; a second flexible circuit board 40 disposed on a side edge of the gate array substrate 30; and a level shifter 41 provided on the second flexible circuit board 40 and electrically connected to the central control board 11, wherein the level shifter raises the gate array driving signal. Through independently disposing the level shifter 41 on a side edge of the gate array substrate 30, it is convenient to adjust and replace elements that convert the driving signal of the gate array, thereby increasing design flexibility of a panel driving circuit.

In one embodiment of the present disclosure, the second flexible circuit board 40 further includes a shift register and an output buffer. The shift register receives the gate array driving signal and generates a temporary gate array drive signal, the level shifter is configured to raise the temporary storage gate array drive signal and transmit the temporary gate array driving signal to the output buffer, and the output buffer outputs a temporary gate array control signal to control a plurality of thin film transistors of the gate array substrate to turn on or turn off.

In one embodiment of the present disclosure, the level shifter 41, the shift register, and the output buffer are mounted to a thin film encapsulation integrated circuit disposed on the second flexible circuit board 40.

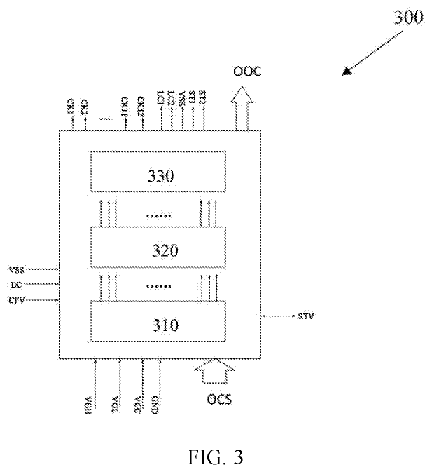

Please refer to FIG. 3, FIG. 3 illustrates a block diagram of a thin film encapsulation integrated circuit according to one embodiment of the present disclosure. As shown in the figure, the thin film encapsulation integrated circuit 300 includes a shift register 310, a level shifter 320, and an output buffer 330. The shift register 310 and the level shifter 320 are electrically connected to the output buffer 330, and the shift register 310 receives the gate array driving signal and generates a temporary gate array driving signal. The level shifter 320 is configured to raise the temporary gate array driving signal and transmits the temporary gate array driving signal to the output buffer 330, and the output buffer 330 outputs a gate array control signal. The gate array driving signal includes a frequency signal CPV, a high gate pulse signal VGH, a low gate pulse signal VGL, a power supply voltage VCC, and a ground voltage GND. In one embodiment of the present disclosure, a shift register 310, a level shifter 320, and an output buffer 330 are electrically connected to each other and are disposed on the second flexible circuit board 40.

The gate array control signal includes a plurality of clock control signals. In other words, the thin film encapsulation integrated circuit 300 can control the gate array with multiple input channels to achieve the effect of increasing the design flexibility of the panel driving circuit.

In the embodiment of FIG. 3, a number of clock control signals is twelve, including a first clock control signal CK1, a second clock control signal CK2, a third clock control signal CK3, a fourth clock control signal CK4, a fifth clock control signal CK5, a sixth clock control signal CK6, a seventh clock control signal CK7, an eighth clock control signal CK8, a ninth clock control signal CK9, a tenth clock control signal CK10, an eleventh clock control signal CK11, and a twelfth clock control signal CK12.

The gate array drive signal includes a low frequency signal LC, and the thin film encapsulation integrated circuit 300 includes a low frequency signal separation module, which converts the low frequency signal LC into a first low frequency signal LC1 and a second low frequency signal LC2 through a low frequency signal separation element. In other words, after the operation of the thin film encapsulation integrated circuit 300, the number of signal channels of low-frequency signals increased, thereby achieving the effects of increasing the design flexibility of the panel driving circuit and improving the accuracy of the gate driving circuit.

In one embodiment of the present disclosure, the second flexible circuit board 40 is configured to further include a scanning direction control element which is configured to control a scanning direction of a gate driving circuit, and control the scanning direction of the gate driving circuit by receiving the scanning direction control signal. Alternatively, in one embodiment of the present disclosure, the scanning direction control element is mounted in the thin film encapsulation integrated circuit 300.

The gate array driving signal includes a start signal ST, the gate second flexible circuit board 40 is configured to include a start signal separation element, and the start signal separation element is configured to convert the start signal into a first start signal ST1 and a second start signal ST2. In other words, by configuring the thin film encapsulation integrated circuit so that the output gate array control signal includes the first start signal ST1 and the second start signal ST2, the design flexibility and the accuracy of the panel driving circuit are improved. Alternatively, in one embodiment of the present disclosure, the starting signal separation element is mounted in the thin film encapsulation integrated circuit 300.

The thin film encapsulation integrated circuit also includes a signal input interface for receiving other control signals OCS and a signal output interface for outputting other output channel OOC signals. The thin film encapsulation integrated circuit 300 is provided with a signal input interface and a signal output interface to achieve the effect of increasing the design flexibility of the panel driving circuit. Alternatively, in one embodiment of the present disclosure, the signal input interface and the signal output interface are directly disposed on the second flexible circuit board 40 and are electrically connected to the shift register 310 and the output buffer 330, respectively.

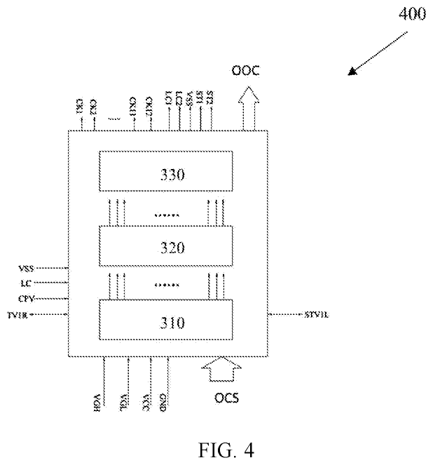

Please refer to FIG. 4. FIG. 4 illustrates a block diagram of a flip-chip integrated circuit according to one embodiment of the present disclosure. The difference from the embodiment of FIG. 3 is that the gate array driving signal includes a left start signal STV1L and a right start signal STV1R. The thin film encapsulation integrated circuit 400 includes a start signal conversion element. The start signal conversion element converts the left start signal STV1L and the right start signal STV1R into a first start signal ST1 and a second start signal ST2. In other words, by configuring thin film encapsulation integrated circuit 400 so that the output gate array control signal includes the first start signal ST1 and the second start signal ST2, the design flexibility and the accuracy of the panel driving circuit are improved.

In one embodiment of the present disclosure, the start signal conversion element obtains the first start signal ST1 and the second start signal ST2 according to the voltage, current, other electrical parameters, signal rising edge and falling edge, and/or signal frequency conversion of the left start signal STV1L and the right start signal STV1R.

Since the display panel provided by the present disclosure includes a gate array substrate; a first flexible circuit board connected to the gate array substrate; a printed-circuit board connected to the first flexible circuit board, and provided with a central control board, wherein the central control board outputs a gate array driving signal; a second flexible circuit board disposed on a side edge of the gate array substrate; and a level shifter provided on the second flexible circuit board and connected to the central control board, wherein the level shifter is configured to raise the gate array driving signal, a reduction in panel manufacturing costs can be achieved, improving panel design flexibility and controlling the scanning direction of the gate drive circuit.

The above are only preferred embodiments of the present disclosure. It should be noted that, for those of ordinary skill in the art, without departing from the principle of the present disclosure, several improvements and retouches can be made, and these improvements and retouches are within the protection scope of the present disclosure.

1. A display panel, comprising:
a gate array substrate;
a first flexible circuit board connected to the gate array substrate;
a printed-circuit board connected to the first flexible circuit board, and is provided with a central control board, wherein the central control board outputs a gate array driving signal;
a second flexible circuit board disposed on a side edge of the gate array substrate; and
a level shifter provided on the second flexible circuit board and connected to the central control board, wherein the level shifter is configured to raise the gate array driving signal.

2. The display panel as claimed in claim 1, wherein the second flexible circuit board further comprises a shift register and an output buffer, the shift register receives the gate array driving signal and generates a temporary gate array driving signal, the level shifter is configured to raise the temporary gate array driving signal and transmit the temporary gate array driving signal to the output buffer, and the output buffer outputs a temporary gate array control signal to control a plurality of thin film transistors of the gate array substrate to turn on or off.

3. The display panel as claimed in claim 2, wherein the shift register, the level shifter, and the output buffer are mounted to a thin film encapsulation integrated circuit disposed on the second flexible circuit board.

4. The display panel as claimed in claim 2, wherein the gate array control signal is configured to comprise a plurality of clock control signals.

5. The display panel as claimed in claim 4, wherein a number of the clock control signals is twelve.

6. The display panel as claimed in claim 1, wherein the gate array driving signal is configured to comprise a low frequency signal, the second flexible circuit board is configured to further comprise a low frequency signal separation element, and the low frequency signal separation element is configured to convert the low frequency signal into a first low frequency signal and a second low frequency signal.

7. The display panel as claimed in claim 1, wherein the second flexible circuit board further comprises a scanning direction control element which is configured to control a scanning direction of a gate driving circuit, and control the scanning direction of the gate driving circuit by receiving a scanning direction control signal.

8. The display panel as claimed in claim 7, wherein the scanning direction control element further comprises a receiving unit that receives the scanning direction control signal.

9. The display panel as claimed in claim 1, wherein the gate array driving signal comprises a start signal, the second flexible circuit board comprises a start signal separation element, and the start signal separation element is configured to convert the start signal into a first start signal and a second start signal.

10. The display panel as claimed in claim 1, wherein the gate array driving signal comprises a left start signal and a right start signal, the second flexible circuit board is configured to further comprise a start signal conversion element, and the start signal conversion element is configured to convert the left start signal and the right start signal into a first start signal and a second start signal.

11. A display panel, comprising:
a gate array substrate;
a first flexible circuit board connected to the gate array substrate;
a printed-circuit board connected to the first flexible circuit board, and is provided with a central control board, wherein the central control board outputs a gate array driving signal;
a second flexible circuit board disposed on a side edge of the gate array substrate; and
a level shifter provided on the second flexible circuit board and connected to the central control board, and the level shifter is configured to raise the gate array driving signal;
wherein the second flexible circuit board further comprises a shift register and an output buffer, the shift register receives the gate array driving signal and generates a temporary gate array driving signal, the level shifter is configured to raise the temporary gate array driving signal and transmit the temporary gate array driving signal to the output buffer, and the output buffer outputs a temporary gate array control signal to control a plurality of thin film transistors of the gate array substrate to turn on or off, and the gate array control signal comprises a plurality of clock control signals.

12. The display panel as claimed in claim 11, wherein the shift register, the level shifter, and the output buffer are mounted to a thin film encapsulation integrated circuit disposed on the second flexible circuit board.

13. The display panel as claimed in claim 11, wherein a number of the clock control signals is twelve.

14. The display panel as claimed in claim 13, wherein the gate array driving signal comprises a low frequency signal, the second flexible circuit board is configured to further comprise a low frequency signal separation element, and the low frequency signal separation element is configured to convert the low frequency signal into a first low frequency signal and a second low frequency signal.

15. The display panel as claimed in claim 11, wherein the second flexible circuit board further comprises a scanning direction control element which is configured to control a scanning direction of a gate driving circuit, and control the scanning direction of the gate driving circuit by receiving a scanning direction control signal.

16. The display panel as claimed in claim 11, wherein the scanning direction control element further comprises a receiving unit that receives the scanning direction control signal.

17. The display panel as claimed in claim 11, wherein the gate array driving signal comprises a start signal, the second flexible circuit board comprises a start signal separation element, and the start signal separation element is configured to convert the start signal into a first start signal and a second start signal.

18. The display panel as claimed in claim 11, wherein the gate array driving signal comprises a left start signal and a right start signal, the second flexible circuit board is configured to further comprise a start signal conversion element, and the start signal conversion element is configured to convert the left start signal and the right start signal into a first start signal and a second start signal.

19. A display panel, comprising:
a gate array substrate;
a first flexible circuit board connected to the gate array substrate;
a printed-circuit board connected to the first flexible circuit board, and is provided with a central control board, wherein the central control board outputs a gate array driving signal;
a second flexible circuit board disposed on a side edge of the gate array substrate; and
a level shifter provided on the second flexible circuit board and connected to the central control board, and the level shifter is configured to raise the gate array driving signal;
wherein the second flexible circuit board further comprises a scanning direction control element which is configured to control a scanning direction of a gate driving circuit, and control the scanning direction of the gate driving circuit by receiving a scanning direction control signal, the scanning direction control element further comprises a receiving unit that receives the scanning direction control signal, the gate array driving signal comprises a start signal, the second flexible circuit board comprises a start signal separation element, and the start signal separation element is configured to convert the start signal into a first start signal and a second start signal.

20. The display panel as claimed in claim 19, wherein the second flexible circuit board further comprises a shift register and an output buffer, the shift register receives the gate array driving signal and generates a temporary gate array driving signal, the level shifter is configured to raise the temporary gate array driving signal and transmit the temporary gate array driving signal to the output buffer, and the output buffer outputs a temporary gate array control signal to control a plurality of thin film transistors of the gate array substrate to turn on or off.
